(19) United States
(12) Patent Application Publication
(10) Pub. No.: US 2024/0380745 A1
(43) Pub. Date: Nov. 14, 2024

(54) CERTIFICATE MANAGEMENT MICROSERVICE

(71) Applicant: RAKUTEN SYMPHONY, INC., Tokyo (JP)

(72) Inventors: Deepak PATIL, Bangalore (IN); Shubhashish BHATTACHARYA, Bangalore (IN); Arun MENON, Bangalore (IN); Soubhik PAL, Bangalore (IN)

(21) Appl. No.: 18/255,365

(22) PCT Filed: Mar. 8, 2023
(86) PCT No.: PCT/US2023/014812

§ 371 Date: Jun. 1, 2023

(30) Foreign Application Priority Data
Oct. 4, 2022 (IN) 202241056984

(51) Int. Cl. H04L 9/40

(52) U.S. Cl. CPC H04L 63/0823

(57) ABSTRACT

A method of operating a cloud-native function (CNF) includes receiving a configuration instruction at a certificate management microservice of the CNF. In response to the configuration instruction, certificate management microservice is initialized, including writing a certificate including a certificate key to a secure storage element. The certificate management microservice receives a service request from an other microservice of the CNF, and in response to the service request, sends certificate information to the other microservice, the certificate information being usable by the other microservice to read the certificate key from the secure storage element.

### PRIORITY CLAIM

The present application claims the priority of Indian Provisional Application No. IN202241056984, filed Oct. 4, 2022, which is incorporated herein by reference in its entirety.

### TECHNICAL FIELD

The present disclosure relates to wireless communication, and more specifically relates to a certificate management microservice for distributed networking nodes in cloud-native radio access network (RAN) and non-RAN applications.

### BACKGROUND

In general, cloud-native network, e.g., RAN and Open RAN, architectures provide large numbers of services and critical applications. Any disaggregated, virtualized, multi-vendor system with many large players is susceptible to security vulnerabilities. The security mechanism in traditional RAN and other networks is relatively straightforward when all the software and hardware in the baseband is proprietary and supplied by a single vendor. But it is not so in new architectures such as the cloud-native RAN.

In a cloud-native RAN (virtualized RAN or vRAN) or other network, software may be disaggregated and often runs on off-the-shelf hardware, and in an Open RAN or other open network, software can come from many different vendors. In a cloud-native approach in which network operations are based on cloud-native network functions (CNFs), the software is containerized with baseband software divided into containerized microservices: PHY, RLC, MAC, transport, and other functions. These microservices are typically orchestrated in a Kubernetes cluster and must securely communicate with each other to function reliably. The communication may be managed by a cloud-native entity called “service mesh” including two parts: (1) the control plane that sets up the communication channels between the microservices, and (2) the data plane that manages the transfer of actual data. The microservices are heterogeneous and highly distributed, and can run on multiple different servers that are geographically and logically separated and might be supplied by different vendors, each providing different baseband functions.

### SUMMARY

In some embodiments, a method of operating a CNF includes receiving a configuration instruction at a certificate management microservice of the CNF, in response to the configuration instruction, initializing the certificate management microservice, wherein initializing the certificate management microservice includes writing a certificate including a certificate key to a secure storage element, receiving, at the certificate management microservice, a service request from an other microservice of the CNF, and in response to the service request, sending certificate information to the other microservice, wherein the certificate information is configured to be usable by the other microservice to read the certificate key from the secure storage element.

In some embodiments, a method of managing digital certificates in a cloud network includes sending a service request from an active microservice of a CNF of the cloud network to a certificate management microservice of the CNF, in response to receiving the service request, sending certificate information from the certificate management microservice to the active microservice, and based on the certificate information, using the active microservice to read a certificate key from a secure storage element.

In some embodiments, a computer-readable medium includes instructions executable by a controller of a network device, e.g., a virtual network function (VNF), to cause the controller to perform operations comprising receiving a configuration instruction at a certificate management microservice of a CNF, in response to the configuration instruction, instantiating the certificate management microservice, wherein instantiating the certificate management microservice includes writing a certificate including a certificate key to a secure storage element, receiving, at the certificate management microservice, a service request from an other microservice of the CNF, and in response to the service request, sending certificate information to the other microservice, wherein the certificate information is configured to be usable by the other microservice to read the certificate key from the secure storage element.

### BRIEF DESCRIPTION OF DRAWINGS

Aspects of the present disclosure are best understood from the following detailed description when read with the accompanying figures. In accordance with the standard practice in the industry, various features are not drawn to scale. In fact, the dimensions of the various features are arbitrarily increased or reduced for clarity of discussion.

FIGS. 1A and 1B are diagrams of a communication system, in accordance with some embodiments.

FIG. 2 is a flowchart of a certificate management method, in accordance with some embodiments.

FIG. 3 is a flowchart of a certificate management method, in accordance with some embodiments.

FIG. 4 a flowchart of a certificate management method, in accordance with some embodiments.

FIG. 5 is a diagram of a certificate management method, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows include embodiments in which the first and second features are formed or positioned in direct contact and include embodiments in which additional features are formed or positioned between the first and second features, such that the first and second features are in indirect contact. In addition, the present disclosure repeats reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of a system or object in use or operation in addition to the orientation depicted in the figures. The system is otherwise oriented (rotated 90 degrees or at other orientations) and the spatially relative descriptors used herein likewise are interpreted accordingly.

In various embodiments, a method and computer readable medium are directed to receiving a configuration instruction at a certificate management microservice of a CNF, in response to the configuration instruction, initializing the certificate management microservice, wherein initializing the certificate management microservice includes writing a certificate including a certificate key to a secure storage element, receiving, at the certificate management microservice, a service request from an other microservice of the CNF, and in response to the service request, sending certificate information to the other microservice, wherein the certificate information is configured to be usable by the other microservice to read the certificate key from the secure storage element. In some embodiments, the method includes one or more of sending an enrolment request from the certificate management microservice to a certification authority (CA), the enrolment request corresponding to an indicated certificate enrolment protocol, using the certificate management microservice to detect an elapsed time greater than a renewal threshold of the certificate, and in response to detecting the elapsed time greater than the renewal threshold, sending an enrolment renewal request from the certificate management microservice to the CA, and in some embodiments, includes sending an initial enrolment renewal request and periodically sending subsequent enrolment renewal requests from the certificate management microservice to the CA.

By performing some or all of the method operations, a microservice level certificate manager can be easily packaged in RAN CNFs, e.g., CUCP, CUUP, 5G DU, and non-RAN CNFs, e.g., Kafka, EMS, FCAPS service, which require operator certificates, can be easily extended to support any new enrolment and re-enrolment protocols, offers gRPC and JSON API based interfaces for communication with other microservices in the CNF, is capable of communicating with registration authorities (RAs) and certification authorities (CAs) for enrolment and re-enrolment as controlled for different customer needs, and can support default certificates usable in customer lab trials and proofs of concept (POCs), e.g., based on the absence of a CA. The certificate management microservice thereby supports multiple enrolment and re-enrolment protocols, e.g., an algorithm being selectable while instantiating the CNF based on customer needs, re-enrolment of the certificate within a configurable window prior to expiration, notification to applications of changes to a device certificate and keys, vendor certificate based authentication and TLS-SRP equivalent methods for enrolment, single or multiple certificates for applications, usage of a secure vault to store keys, varying certificate profiles corresponding to 3GPP and O-RAN specifications, and operator specified alarms during enrolment or re-enrolment failures. Compared to other approaches, e.g., namespace level or cluster level certificate management provided by Kubernetes (K8s), digital certificates are capable of being automatically managed more extensively and efficiently in cloud-native networking applications, e.g., RAN and Open RAN applications.

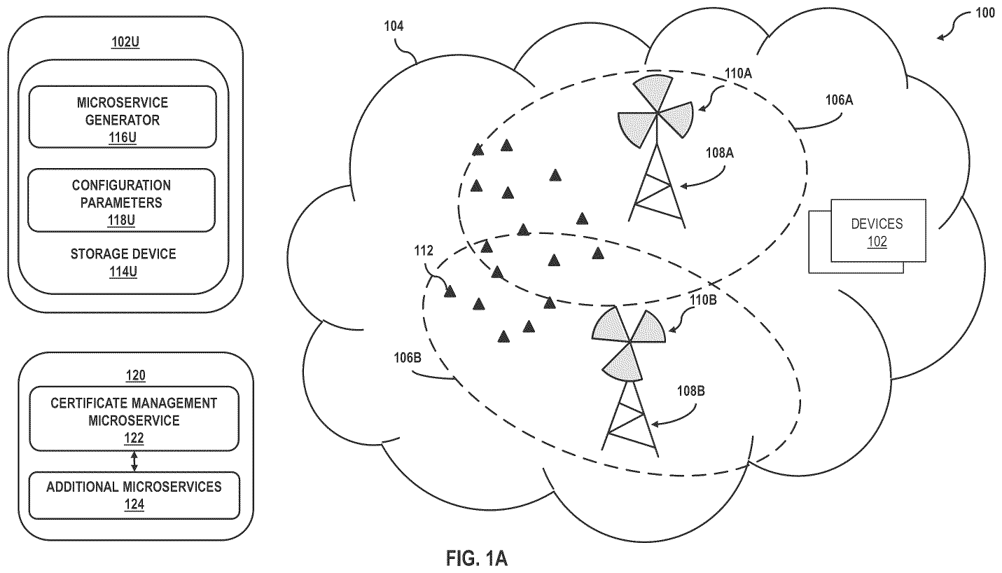

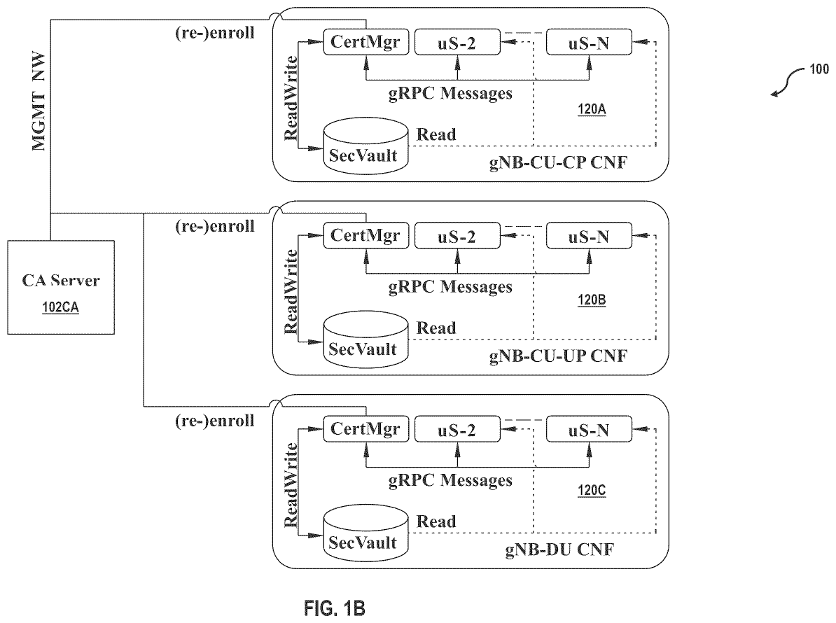

FIG. 1A is a diagram of a networking system 100 (hereinafter referred to as “system 100”), in accordance with some embodiments, and FIG. 1B is a diagram of a portion of system 100, in accordance with some embodiments. Each of FIGS. 1A and 1B is simplified for the purpose of illustration.

System 100 includes a plurality of interconnected devices 102 configured as some or all of a network 104. In various embodiments, devices 102 correspond to combinations of computing devices, computing systems, servers, server clusters, and/or pluralities of server clusters also referred to as server farms or data centers in some embodiments. The combination of interconnected devices 102 includes processing circuitry configured to be usable to perform some or all of the various operations discussed herein.

In some embodiments, one or more of devices 102 are virtualized network components, e.g., virtualized network functions (VNFs) such as cloud-native network functions (CNFs), including software configured to implement one or more network functions by running on one or more hardware devices. In some embodiments, some or all of devices 102 are configured as some or all of a network function virtualization infrastructure (NFVI). Other configurations and/or types of devices 102 are within the scope of the present disclosure.

FIG. 1A depicts an instance of devices 102, a device 102U, and a CNF 120, each of which is further discussed below.

In some embodiments, network 104 includes one or more radio access networks (RANs) or a portion of a RAN. In some embodiments, a RAN is a mobile telecommunication system that implements a radio access technology (RAT) and resides between instances of user equipment (UE) 112, e.g., mobile phones, computers, or the like, and provides connection with devices 102. In some embodiments, a RAN is an open RAN (O-RAN).

In some embodiments, one or more of devices 102 are configured to perform management functions corresponding to network 104. In various embodiments, one or more of devices 102 are configured as one or more of an operations support system (OSS), an element management system (EMS), a network management system (NMS), an access and mobility management function (AMF), or other system or function configured to perform one or more activities supporting operations of network 104.

In some embodiments, one or more of the interconnected devices 102 of network 104 are configured as one or more of a local area network (LAN), a wide area network (WAN), a metropolitan area network (MAN), an internet area network (IAN), a campus area network (CAN), or a virtual private network (VPN). In some embodiments, one or more of the interconnected devices 102 of network 104 are configured as a backbone or core network (CN), a part of a computer network that interconnects networks, providing a path for the exchange of information between different LANs, WANs, etc.

In some embodiments, some of the interconnected devices 102 of network 104 are configured as server clusters, e.g., included in a data center. In some embodiments, the server clusters are part of a cloud computing environment.

In some embodiments, network 104 is some or all of a global system for mobile communications (GSM) RAN, a GSM/EDGE RAN, a universal mobile telecommunications system (UMTS) RAN (UTRAN), an evolved universal terrestrial radio access network (E-UTRAN), open RAN (O-RAN), or cloud-RAN (C-RAN). In some embodiments, network 104 resides between a UE 112 and one or more core networks of system 100.

In some embodiments, network 104 is some or all of a hierarchical telecommunications network, e.g., system 100, including one or more intermediate link(s), also referred to as backhaul portions in some embodiments, between a RAN and one or more core networks. Non-limiting examples of mobile backhaul implementations include fiber-based backhaul, wireless point-to-point backhaul, copper-based wireline, satellite communications, and point-to-multipoint wireless technologies. In some embodiments, backhaul refers to the side of the network that communicates with the global internet.

In the embodiment depicted in FIG. 1A, network 104 includes cells 106A and 106B, which include respective base stations 108A and 108B and respective antennas 110A and 110B. In some embodiments, network 104 includes a plurality of cells including cells 106A and 106B and collectively referred to as cells 106 or, in some embodiments coverage areas 106, a plurality of base stations including base stations 108A and 108B and collectively referred to as base stations 108, and a plurality of antennas including antennas 110A and 110B and collectively referred to as antennas 110.

In the embodiment depicted in FIG. 1A, a single base station 108 corresponds to single instances of each of cells 106 and antennas 110. In various embodiments, a single base station 108 corresponds to more than one instance of cells 106 and/or more than one instance of antennas 110.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, a base station 108 is a cellular-enabled mobile device site where antennas and electronic communications equipment are placed, typically on a radio mast, tower, or other raised structure to create a cell 106 (or adjacent cells) in a network. The raised structure typically supports antenna(s) 110 and one or more sets of transmitter/receivers, transceivers, digital signal processors, control electronics, a remote radio head (RRH), primary and backup electrical power sources, and sheltering. Base stations 108 are known by other names such as base transceiver station, mobile phone mast, or cell tower. In some embodiments, base stations 108 are edge devices configured to wirelessly communicate with UEs 112. The edge device provides an entry point into service provider core networks. Examples include routers, routing switches, integrated access devices (IADs), multiplexers, and a variety of MAN and WAN access devices.

In at least one embodiment, an instance of antenna 110 is a sector antenna, e.g., a directional microwave antenna with a sector-shaped radiation pattern, or a plurality of sector antennae, e.g., configured to have a full-circle coverage area 106. In some embodiments, an instance of antenna 110 is a circular antenna. In some embodiments, an instance of antenna 110 operates at one or more microwave or ultra-high frequency (UHF) frequencies, e.g., ranging from 300 Megahertz (MHz) to 7.2 Gigahertz (GHz). In some embodiments, an instance of antenna 110 operates at one or more frequencies ranging from 24.2 GHz to 71.0 GHz.

In various embodiments, a cell 106 is a three-dimensional space having a shape and size based on the configurations of the corresponding base station 108, e.g., a power level, and antenna 110, e.g., a number of sectors. In various embodiments, a cell 106 has a substantially spherical, hemispherical, conical, columnar, circular or oval disc, or other shape corresponding to a base station and antenna configuration. In various embodiments, one or both of the shape or size of a cell 106 varies over time, e.g., based on a variable base station power level and/or a variable number of activated antennae and/or antenna sectors. In some embodiments, a cell 106 is referred to as a macro-cell, a micro-cell, a pico-cell, a femto-cell, or a small cell. In some embodiments, a cell 106 is referred to as an indoor small cell (IDSC).

In some embodiments, an instance of UE 112 is a computer or computing system. In some embodiments, an instance of UE 112 has a liquid crystal display (LCD), light-emitting diode (LED) or organic light-emitting diode (OLED) screen interface, such as a graphical user interface providing a touchscreen interface with digital buttons and keyboard or physical buttons along with a physical keyboard. In some embodiments, an instance of UE 112 connects to the internet and interconnects with other devices. In some embodiments, an instance of UE 112 incorporates integrated cameras, the ability to place and receive voice and video telephone calls, video games, and Global Positioning System (GPS) capabilities. In some embodiments, an instance of UE 112 performs as a virtual machine or allows third-party apps to run as a container. In some embodiments, an instance of UE 112 is a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

A UE 112 is configured to communicate with base stations 108 via signals transmitted to and from antennas 110.

Network 104 includes a plurality of network nodes, referred to as nodes or RAN nodes in some embodiments. In some embodiments, a node corresponds to one or more devices 102, a combination of one or more devices 102 and one or more base stations 108, or one or more base stations 108. In some embodiments, a node corresponds to a base station 108 that is an instance of devices 102.

In some embodiments, a node corresponds to a device 102 configured as a centralized unit (CU) and one or more base stations 108 configured as distributed units (DUs). In some embodiments, a node is a next generation RAN (NG-RAN) node, e.g., a gNB an NG-eNB according to 3GPP TS 38.300 specifications.

Nodes are interconnected to each other and to network management entities, e.g., an EMS or AMF, through various interfaces. In some embodiments, interfaces between nodes and core network elements are referred to as NG interfaces. In some embodiments, interfaces between various nodes, e.g., NG-RAN nodes, are referred to as Xn interfaces.

In the embodiment depicted in FIG. 1A, device 102U is a device configured to deploy one or more applications to network 104. Device 102U includes a storage device 114U configured to store a microservice generator 116U and configuration parameters 118U. In the embodiment depicted in FIG. 1A, device 102U is a single instance of devices 102. In some embodiments, device 102U includes more than one instance of devices 102.

A storage device, e.g., storage device 114U, is one or more computer-readable, non-volatile storage media including one or more of dynamic memory (e.g., RAM, magnetic disk, writable optical disk, or the like) and static memory (e.g., ROM, CD-ROM, or the like) configured to store executable instructions that when executed perform the operations described herein to facilitate automated certificate management. In some embodiments, storage device 114U is also configured to store data associated with or generated by the execution of the operations, e.g., configuration parameters 118U.

In the embodiment depicted in FIG. 1A, storage device 114U is located on device 102U. In some embodiments, storage device 114U is located partially or entirely externally to device 102U, e.g., on one or more servers corresponding to devices 102.

Microservice generator 116U is one or more sets of instructions configured to be executed on device 102U whereby CNF 120 is deployed and/or managed on network 104. Configuration parameters 118U is a set of data records configured to be usable by CNF 120 as discussed below with respect to method 200.

CNF 120 is an application configured to perform one or more networking functions or applications of network 104. In some embodiments, CNF 120 includes a CU CNF or a DU CNF of a RAN or an O-RAN. In some embodiments, CNF 120 includes one of CNFs 120A-120C discussed below with respect to FIG. 1B. In some embodiments, CNF 120 is an application of a network other than a RAN or O-RAN.

CNF 120 includes a certificate management microservice 122 and additional microservices 124. Each of certificate management microservice 122 and additional microservices 124 includes a set of instructions configured to perform one or more networking functions as a component, e.g., a pod, of CNF 120. Certificate management microservice 122 and additional microservices 124 are configured to, in operation, communicate with each other through one or more application programming interfaces (APIs), e.g., a gRPC/JSON API.

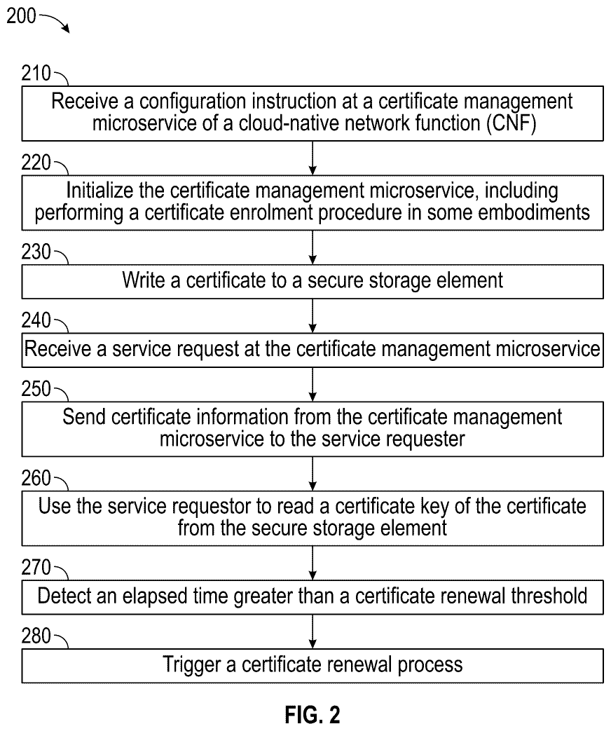

CNF 120 and certificate management microservice 122 are configured to perform some or all of the operations of a method 200 discussed below with respect to FIGS. 2-5.

In the embodiment depicted in FIG. 1B, system 100 includes network 104 configured as a RAN or O-RAN including three instances of CNF 120, CNFs 120A-120C, and an instance of device 102, CA server 102CA. CNF 120A is configured as a gNB-CU-CP (control plane) CNF, CNF 120B is configured as a gNB-CU-UP (user plane) CNF, and CNF 120C is configured as a gNB-DU CNF.

CA server 102CA includes one or more servers configured as a certification authority (CA), an entity configured to store, sign, and issue digital certificates in accordance with one or more enrolment procedures based on one or more certificate enrolment protocols.

Each of CNFs 120A-120C includes an instance of certificate management microservice 122, CertMgr, and instances of additional microservices 124, uS-2 through uS-N corresponding to a total of N microservices. Microservices CertMgr and uS-2 through uS-N are configured to, in operation, communicate, e.g., send and receive service messages, through gRPC messages.

Each instance of CertMgr is configured to read and write digital certificate information, e.g., digital certificates including public keys, to a corresponding instance of a secure vault Sec Vault, and each instance of microservices uS-2 through uS-N is configured to read the digital information from the corresponding instance of secure vault SecVault.

In the embodiment depicted in FIG. 1B, each instance of CertMgr is configured as a first microservice of the corresponding CNF 120A-120C. In some embodiments, one or more instances of CertMgr is configured as a different microservice of the corresponding CNF 120A-120C such that a first microservice uS-1 is included in additional microservices 124.

CNFs 120A-120C including the instances of CertMgr are configured to perform some or all of the operations of method 200 discussed below with respect to FIGS. 2-5.

System 100 including one or more instances of CNF 120 configured as discussed above so to perform some or all of method 200 is thereby configured to obtain the benefits discussed below with respect to method 200.

FIG. 2 is a flowchart of certificate management method 200, in accordance with some embodiments. Certificate management method 200, also referred to as a method 200 or a method of operating a CNF in some embodiments, is operable on a networking system, e.g., system 100 discussed above with respect to FIGS. 1A and 1B.

Additional operations may be performed before, during, between, and/or after the operations of method 200 depicted in FIG. 2, and some other operations may only be briefly described herein. In some embodiments, other orders of operations of method 200 are within the scope of the present disclosure. In some embodiments, one or more operations of method 200 are not performed.

In some embodiments, some or all of the operations of method 200 are included in another method, e.g., a method of operating a networking system. In some embodiments, some or all of the operations of method 200 discussed below are repeated, e.g., as part of operating a networking system.

In some embodiments, some or all of the operations of method 200 discussed below are capable of being performed automatically, e.g., by CNF 120 including certificate management microservice 122, each discussed above with respect to FIGS. 1A and 1B.

The operations of method 200 are discussed below with reference to various features of system 100 that are also discussed above respect to FIGS. 1A and 1B.

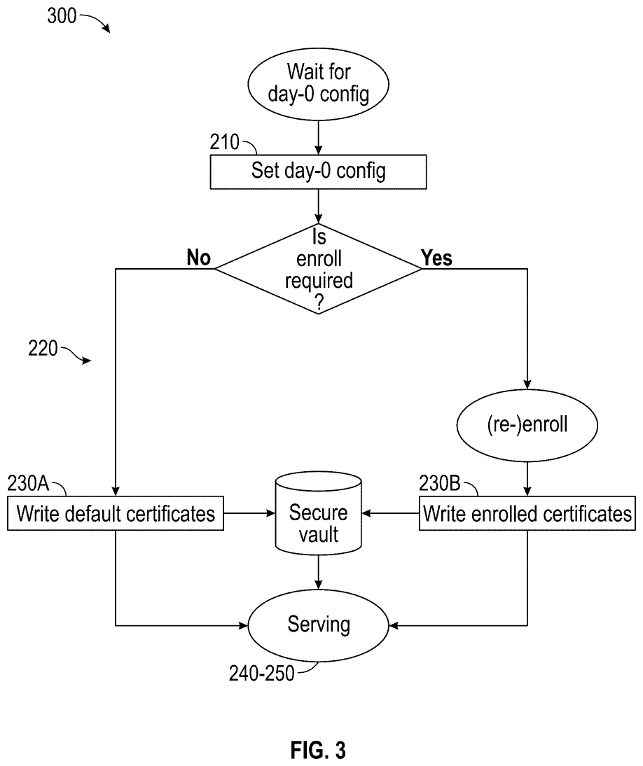

FIGS. 3-5 depict non-limiting examples that illustrate the execution of some or all of the operations of method 200 using embodiments of system 100, as discussed below.

At operation 210, in some embodiments, a configuration instruction is received at a certificate management microservice of a CNF. In some embodiments, receiving the configuration instruction includes receiving a set of Day-0 parameters, e.g., the example Day-0 parameters presented below in Table 1. In some embodiments, receiving the configuration instruction at the certificate management microservice of the CNF includes receiving configuration parameters 118U at certificate management microservice 122 of CNF 120, e.g., a CertMgr of one of CNFs 120A-120C.

In some embodiments, receiving the configuration instruction at the certificate management microservice of the CNF includes deploying one or more of the certificate management microservice, the CNF, or an application including the certificate management microservice and the CNF, e.g., by using microservice generator 116U. In various embodiments, deploying one or more of the certificate management microservice, CNF, or application includes launching a new instance of the certificate management microservice, CNF, or application, or performing an update to an existing certificate management microservice, CNF, or application.

In some embodiments, deploying one or more of the certificate management microservice, CNF, or application includes starting an operational mode in which the one or more of the certificate management microservice, CNF, or application is configured to wait to receive the instruction.

In some embodiments, receiving the configuration instruction at the certificate management microservice includes receiving a push from a network device, e.g., device 102U. In some embodiments, receiving a push from a network device includes receiving the push from a network operator.

At operation 220, in some embodiments, the certificate management microservice is initialized. In some embodiments, initializing the certificate management microservice includes initializing certificate management microservice 122 of CNF 120, e.g., a CertMgr of one of CNFs 120A-120C.

In some embodiments, initializing the certificate management microservice corresponds to performing a Day-0 operation. In some embodiments, initializing the certificate management microservice corresponds to instantiating one or more application pods.

In some embodiments, initializing the certificate management microservice is based on the received configuration instruction, e.g., configuration parameters 118U. In some embodiments, initializing the certificate management microservice is based on the Day-0 parameters of Table 1 below.

TABLE 1
Day −0 Parameters Example

| Day −0 | | | | | |
|---|---|---|---|---|---|
| Parameter | Description | VNF(CMPv2) | VNF(EST) | PNF(CMPv2) | PNF(EST) |
| Protocol | Specify enrolment to be | (Required) | (Required) | (Required) | (Required) |
| Indication | performed using ESTor | | | | |
| | CMPv2 | | | | |
| CAFQDN/IP | CAFQDN/IP | (Required) | (Required) | (Required) | (Required) |
| CA Port | Port on which CA | (Required) | (Required) | (Required) | (Required) |
| | service is running | | | | |
| Hostname | NF Hostname which will | (Required) | (Required) | (Required) | (Required) |
| | used as the identity for | | | | |
| | enrolment procedures | | | | |
| TLS-SRP | Required by NF not | | (Required) | | |
| Username | having factory | | | | |
| | certificate | | | | |
| TLS-SRP | Required by NF not | | (Required) | | |
| Password | having factory | | | | |
| | certificate | | | | |
| CA | The use is described in | (Required) | | (Required) | |
| SubjectName | 3GPP TS 33.310 | | | | |
| | clause 9.5.3. | | | | |
| CA Path | Path to the CA server | (Required) | | (Required) | |
| | directory | | | | |
| Shared | | (Required) | | | |
| Secret | | | | | |
| Reference | It is applicable only for | (Required) | | | |
| Number | Shared secrete based | | | | |
| | message protection; | | | | |
| | refnum and key are | | | | |
| | character strings shared | | | | |
| | among the CA and the | | | | |
| | client. refnum identifies | | | | |
| | the secret key used to | | | | |
| | authenticate the message | | | | |
| Root CA | Issuer | | | | (Required) |
| including | certificates(Complete trust | | | | |
| Issuing CA | chain) of CA server | | | | |
| | certificate | | | | |

The non-limiting example of a set of Day-0 parameters presented in Table 1 includes, for each Day-0 parameter listed in the first column, a description in the second column, and an indication in each subsequent column as to whether the Day-0 parameter is required to be defined for the corresponding one of four defined certificate enrolment protocols: a VNF certificate management protocol-version 2 (CMPv2); a VNF enrolment over secure transport (EST); a physical network function (PNF) (CMPv2); and a PNF (EST). Parameters CA FQDN/IP, CA PORT, CA SubjectName, CA PATH, Shared Secret, Reference Number, and Root CA including Issuing CA are identifiers configured to enable communication with a certification authority, e.g., CA server 102CA. Protocol Indication is configured to identify a certificate enrolment protocol, e.g., EST, CMP, CMPv2, or simple certificate enrolment protocol (SCEP). Parameters TLS Username and TLS Password are authentication parameters configured in accordance with transport layer security (TLS) secure remote password (SRP) operation using VNF EST. Parameter Hostname is an identifier corresponding to the host NF, e.g., CNF 120.

In some embodiments, initializing the certificate management microservice includes setting a certificate enrolment protocol, e.g., in response to the received set of parameters. In some embodiments, setting a certificate enrolment protocol includes setting the certificate enrolment protocol corresponding to one of EST, CMP, CMPv2, or SCEP.

In some embodiments, initializing the certificate management microservice includes determining whether or not to perform a certificate enrolment procedure, e.g., based on the received configuration instruction. In some embodiments, determining whether or not to perform a certificate enrolment procedure includes determining that a CA or RA is not available, e.g., based on one or more received parameters.

In some embodiments, initializing the certificate management microservice includes authenticating the certificate management microservice to a secure storage element, e.g., a secure vault or a persistent volume such as a non-volatile memory. In some embodiments, authenticating the certificate management microservice to the secure storage element is based on one or more received parameters. In some embodiments, authenticating the certificate management microservice to the secure storage element includes authenticating the certificate management microservice to a secure vault Sec Vault of one of CNFs 120A-120C.

In some embodiments, authenticating the certificate management microservice to the secure storage element includes integrating the certificate management microservice to an external secure vault, e.g., a secure vault commissioned by an end user of the CNF.

In some embodiments, authenticating the certificate management microservice to the secure storage element includes deploying a secure storage element. In some embodiments, deploying a secure storage element includes setting up a secure vault, e.g., by using Hashicorp software.

In some embodiments, initializing the certificate management microservice includes writing one or more certificates to the secure storage element, e.g., by executing some or all of operation 230 discussed below.

A certificate as discussed herein is a digital certificate configured in accordance with one or more standards so as to be usable by outside entities to certify that a named subject of the certificate has ownership of a public key included in the certificate. In some embodiments, a certificate has a certificate profile based on a 3GPP or O-RAN specification.

In some embodiments, initializing the certificate management microservice includes performing a certificate enrolment procedure. Performing a certificate enrolment procedure includes performing one of an initial enrolment procedure or a re-enrolment procedure on a given certificate.

Performing a certificate enrolment procedure includes the certificate management microservice communicating with a CA, e.g., based on one or more CA identifier parameters included in configuration parameters 118U, using a certification enrolment protocol, e.g., based on one or more parameters included in configuration parameters 118U.

In some embodiments, performing the enrolment procedure includes performing the procedure corresponding to one of EST, CMP, CMPv2, or SCEP. In some embodiments, performing the enrolment procedure includes using one or both of libopenssl or libest software.

In some embodiments, performing the enrolment procedure includes starting a renewal timer corresponding to performing the enrolment procedure on the given certificate.

In some embodiments, performing the enrolment procedure includes one or both of sending an enrolment renewal request to the certification authority or sending a renewal notification to a user of the CNF.

In some embodiments, performing the enrolment procedure includes repeating performing an enrolment procedure for multiple microservices of the CNF.

At operation 230, in some embodiments, a certificate is written to the secure storage element.

In some embodiments, writing a certificate to the secure storage element includes writing a certificate enrolled by performing some or all of operation 220 discussed above. In some embodiments, writing a certificate to the secure storage element includes writing a default certificate included in or linked to the CNF. In some embodiments, writing a certificate to the secure storage element includes writing an operator-signed certificate to the secure storage element.

At operation 240, in some embodiments, a service request is received at the certificate management microservice. Receiving the service request includes receiving the service request corresponding to a key of a certificate associated with the CNF and stored in the secure storage element.

Receiving the service request includes receiving the service request from a microservice of the CNF other than the certificate management microservice or from a management system of the network in which the CNF is deployed, e.g., a configuration management system (ConfD), a performance management system (PerfMgr), or an IP security management system (IpsecMgr).

In some embodiments, receiving the service request at the certificate management microservice includes receiving the service request at certificate management microservice 122 or CertMgr from an additional microservice 124 or uS-2 through uS-N.

In some embodiments, receiving the service request at the certificate management microservice includes receiving the service request through an API, e.g., using a gRPC message.

At operation 250, in some embodiments, certificate information is sent from the certificate management microservice to the service requester. Sending the certificate information from the certificate management microservice to the service requester includes sending the certificate information configured to be usable by the service requester to read the certificate and/or the certificate key from the secure storage element.

In some embodiments, sending the certificate information from the certificate management microservice includes sending the certificate information from certificate management microservice 122 or CertMgr to an additional microservice 124 or uS-2 through uS-N.

At operation 260, in some embodiments, the service requestor is used to read a certificate key of the certificate from the secure storage element. In some embodiments, using the service requester includes using an additional microservice 124 or uS-2 through uS-N to read a certificate key from, e.g., Sec Vault.

At operation 270, in some embodiments, an elapsed time greater than a certificate renewal threshold is detected. Detecting the elapsed time greater than the certificate renewal threshold includes the certificate management microservice detecting the elapsed time greater than the certificate renewal threshold based on having started the renewal timer in operation 230.

In some embodiments, detecting the elapsed time greater than the certificate renewal threshold includes the certificate renewal threshold being based on a percentage of a validity period of the certificate.

At operation 280, in some embodiments, a certificate renewal process is triggered. In some embodiments, triggering the certificate renewal process includes performing some or all of operation 230 discussed above.

In some embodiments, sending the enrolment renewal request from the certificate management microservice to the CA comprises sending an initial enrolment renewal request, and periodically sending subsequent enrolment renewal requests from the certificate management microservice to the CA.

In some embodiments, triggering the certificate renewal process includes sending a renewal notification to a user of the CNF. In some embodiments, triggering the certificate renewal process includes determining a failure of the renewal process and based on determining the failure, sending a second enrolment renewal request to the CA and sending a failure notification, e.g., an alarm, to the user of the CNF.

In some embodiments, performing operations 270 and 280 includes performing some or all of the following operations:

When a current system date/time crosses a “certificate issuance date”+(“renewal threshold”*“certificate validity period”), certificate renewal process shall be triggered. At the same time, the device shall generate alarm “Operator Device certificate going to expire in ‘n’ days”. This alarm shall be cleared after successful renewal of the certificate.

E.g. if “certificate validity period”=100 days, “renewal threshold”=60% then certificate renewal shall be triggered when the current system date crosses “certificate issuance date”+60 days.

Certificate renewal can be triggered either immediately when the above conditions are met or at a predefined interval after the above condition are met, e.g., at the beginning of an hour after conditions are met. Since the certificate validity period could be in hours, it is useful to ensure that certificate renewal is triggered based on either of the above logic.

On power-on, if the device realizes that the current system date/time has already crossed the “certificate issuance date”+(“renewal threshold”*“certificate validity period”), then the device shall trigger certificate renewal process as discussed above. At the same time, the device shall generate alarm “Operator Device certificate going to expire in ‘n’ days”. This alarm shall be cleared after successful renewal of the certificate.

On power-on, if the device determines that the certificate has already expired, then the device shall trigger certificate enrolment process using other credential. At the same time, the device shall generate alarm “Operator Device certificate has expired”. This alarm shall be cleared after successful enrolment of the certificate.

Virtual machines (VMs) shall use TLS-SRP credential provided as part of day-0 configuration. RU/gNB-DU shall use vendor/factory provisioned certificate.

If the renewal procedure fails then during the remaining period (while the certificate is valid), the device shall re-attempt certificate renewal periodically at least 10 times. E.g. if there are 40 days remaining then renewal shall be tried at least 10 times (until it is successful) in this period. Same is true if there are 4 days remaining

By performing some or all of the operations of method 200, a system, e.g., system 100, automatically performs some or all of receiving a configuration instruction at a certificate management microservice of a CNF, in response to the configuration instruction, initializing the certificate management microservice, wherein initializing the certificate management microservice includes writing a certificate including a certificate key to a secure storage element, receiving, at the certificate management microservice, a service request from an other microservice of the CNF, and in response to the service request, sending certificate information to the other microservice, wherein the certificate information is configured to be usable by the other microservice to read the certificate key from the secure storage element. In some embodiments, the method includes one or more of sending an enrolment request from the certificate management microservice to a CA, the enrolment request corresponding to an indicated certificate enrolment protocol, using the certificate management microservice to detect an elapsed time greater than a renewal threshold of the certificate, and in response to detecting the elapsed time greater than the renewal threshold, sending an enrolment renewal request from the certificate management microservice to the CA, and in some embodiments, includes sending an initial enrolment renewal request and periodically sending subsequent enrolment renewal requests from the certificate management microservice to the CA.

By performing some or all of the method operations, a microservice level certificate manager can be easily packaged in RAN CNFs, e.g., CUCP, CUUP, 5G DU, and non-RAN CNFs, e.g., Kafka, EMS, FCAPS service, which require operator certificates, can be easily extended to support any new enrolment and re-enrolment protocols, offers gRPC and JSON API based interfaces for communication with other microservices in the CNF, is capable of communicating with RAs and CAs for enrolment and re-enrolment as controlled for different customer needs, and can support default certificates usable in customer lab trials and POCs, e.g., based on the absence of a CA. The certificate management microservice thereby supports multiple enrolment and re-enrolment protocols, e.g., an algorithm being selectable while instantiating the CNF based on customer needs, re-enrolment of the certificate within a configurable window prior to expiration, notification to applications of changes to a device certificate and keys, vendor certificate based authentication and TLS-SRP equivalent methods for enrolment, single or multiple certificates for applications, usage of a secure vault to store keys, varying certificate profiles corresponding to 3GPP and O-RAN specifications, and operator specified alarms during enrolment or re-enrolment failures. Compared to other approaches, e.g., namespace level or cluster level certificate management provided by Kubernetes (K8s), digital certificates are capable of being automatically managed more extensively and efficiently in cloud-native networking applications, e.g., RAN and Open RAN applications.

FIG. 3 is a flowchart of a certificate management method 300, in accordance with some embodiments. Certificate management method 300, also referred to as method 300 or a method of operating a CNF 300 in some embodiments, is a non-limiting example of some or all of method 200 discussed above.

Method 300 corresponds to operations 210-250 as depicted in FIG. 3. In the embodiment depicted in FIG. 3, operation 230 of method 200 corresponds to separate operations 230A and 230B of method 300 based on whether or not an enrolment is required. If not required, at operation 230A, writing a certificate to the secure storage element includes writing one or more default certificates to the secure storage element. If required, at operation 230B, writing a certificate to the secure storage element includes writing one or more enrolled certificates to the secure storage element after performing an enrolment and/or re-enrolment process.

By executing some or all of the operations of method 200 in accordance with the non-limiting example of method 300, the benefits discussed above with respect to FIGS. 1A-2 are capable of being realized.

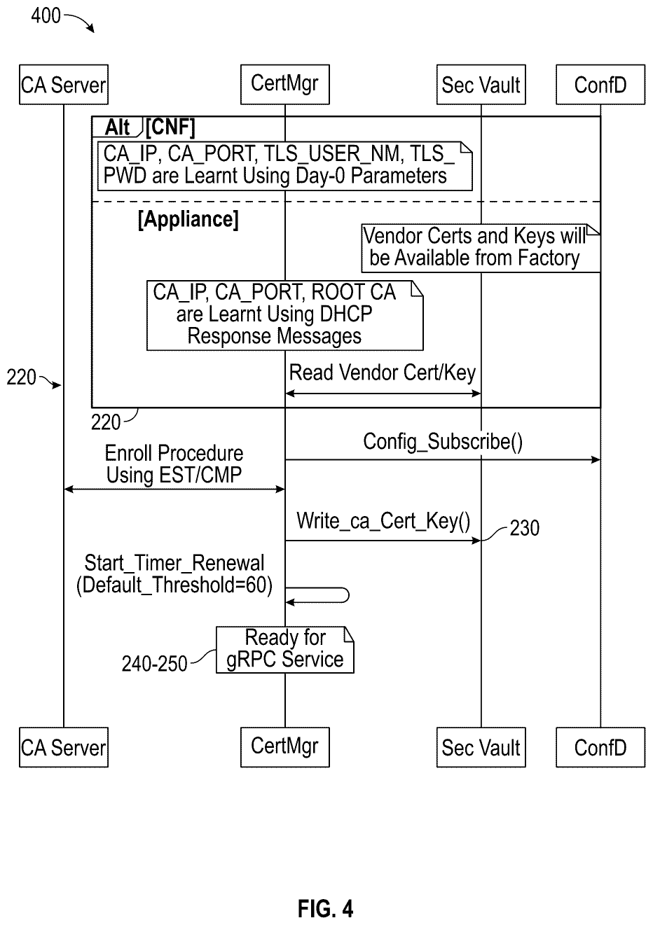

FIG. 4 is a flowchart of a certificate management method 400, in accordance with some embodiments. Certificate management method 400, also referred to as method 400 or a method of operating a CNF 400 in some embodiments, is a non-limiting example of some or all of method 200 discussed above

Method 400 corresponds to operations 220-250 as depicted in FIG. 4.

By executing some or all of the operations of method 200 in accordance with the non-limiting example of method 400, the benefits discussed above with respect to FIGS. 1A-2 are capable of being realized.

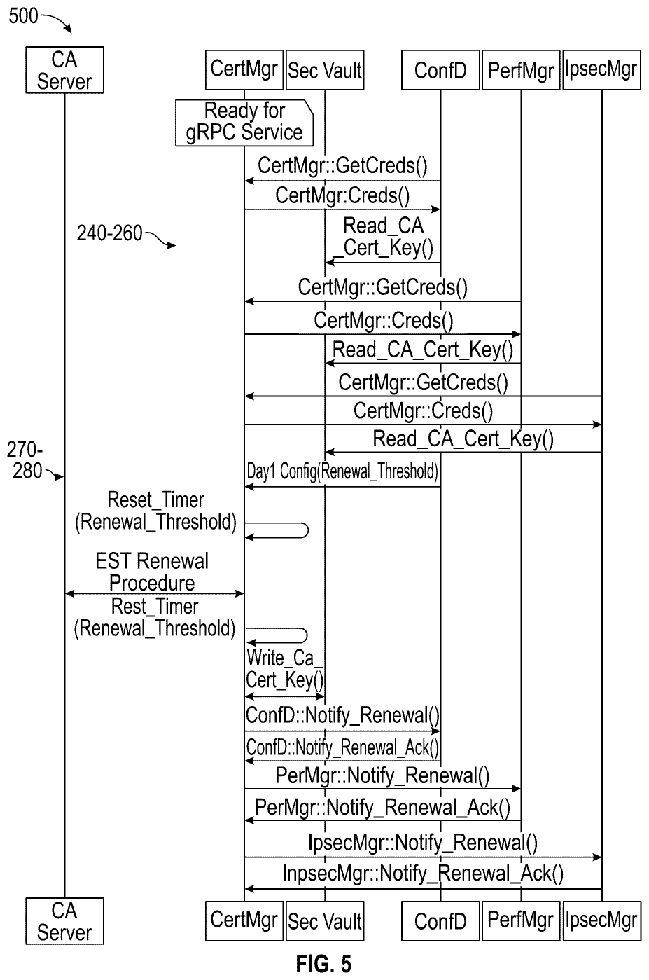

FIG. 5 is a flowchart of a certificate management method 500, in accordance with some embodiments. Certificate management method 500, also referred to as method 500 or a method of operating a CNF 500 in some embodiments, is a non-limiting example of some or all of method 200 discussed above

Method 500 corresponds to operations 240-280 as depicted in FIG. 5.

By executing some or all of the operations of method 200 in accordance with the non-limiting example of method 500, the benefits discussed above with respect to FIGS. 1A-2 are capable of being realized.

In some embodiments, a method of operating a CNF includes receiving a configuration instruction at a certificate management microservice of the CNF, in response to the configuration instruction, initializing the certificate management microservice, wherein the initializing the certificate management microservice includes writing a certificate including a certificate key to a secure storage element, receiving, at the certificate management microservice, a service request from an other microservice of the CNF, and in response to the service request, sending certificate information to the other microservice, wherein the certificate information is configured to be usable by the other microservice to read the certificate key from the secure storage element. In some embodiments, initializing the certificate management microservice includes integrating the certificate management microservice to the secure storage element comprising a secure vault or a persistent volume. In some embodiments, initializing the certificate management microservice further includes setting a certificate enrolment protocol. In some embodiments, initializing the certificate management microservice includes instantiating the certificate manager based on a set of parameters including authentication parameters. In some embodiments, initializing the certificate management microservice includes performing an enrolment procedure on the certificate with a certification authority based on the set of parameters, and starting a renewal timer corresponding to performing the enrolment procedure on the certificate. In some embodiments, the method includes detecting that an elapsed time of the renewal timer exceeds a renewal threshold, and in response the detecting that the elapsed time exceeds the renewal threshold, sending an enrolment renewal request to the certification authority and sending a renewal notification to a user of the CNF. In some embodiments, the method includes, based on a failure of the enrolment renewal request, sending a second enrolment renewal request to the certification authority and sending a failure notification to the user of the CNF. In some embodiments, writing the certificate including the certificate key to the secure storage element includes writing an operator-signed certificate to the secure storage element. In some embodiments, writing the certificate including the certificate key to the secure storage element includes writing a default certificate to the secure storage element. In some embodiments, the CNF includes one of a CU CNF or a DU CNF of a radio access network RAN.

In some embodiments, a method of managing digital certificates in a cloud network includes sending a service request from an active microservice of a CNF of the cloud network to a certificate management microservice of the CNF, in response to receiving the service request, sending certificate information from the certificate management microservice to the active microservice, and based on the certificate information, using the active microservice to read a certificate key from a secure storage element. In some embodiments, the method includes pushing a configuration message to the certificate management microservice, and in response to receiving the configuration message, instantiating the certificate management microservice including a certificate including the certificate key to the secure storage element. In some embodiments, pushing the configuration message to the certificate management microservice includes pushing the configuration message including a set of configuration parameters including one or more identifiers corresponding to a certification authority CA and a certificate enrolment protocol. In some embodiments, the method includes, based on the one or more identifiers, sending an enrolment request from the certificate management microservice to the CA, wherein the enrolment request corresponds to the certificate enrolment protocol. In some embodiments, the method includes using the certificate management microservice to detect an elapsed time greater than a renewal threshold of the certificate, and in response to detecting the elapsed time greater than the renewal threshold, sending an enrolment renewal request from the certificate management microservice to the CA. In some embodiments, sending the enrolment renewal request from the certificate management microservice to the CA includes sending an initial enrolment renewal request, and the method includes periodically sending subsequent enrolment renewal requests from the certificate management microservice to the CA. In some embodiments, using the active microservice to read the certificate key includes reading the certificate key corresponding to a certificate profile based on a 3GPP or O-RAN specification. In some embodiments, the active microservice is a first active microservice of a plurality of active microservices of the CNF, and the method includes sending additional certificate information from the certificate management microservice to a second active microservice of the plurality of active microservices, and based on the additional certificate information, using the second active microservice to read another certificate key from the secure storage element. In some embodiments, the cloud network includes an O-RAN.

In some embodiments, a computer-readable medium includes instructions executable by a controller of a network device, e.g., a VNF, to cause the controller to perform operations comprising receiving a configuration instruction at a certificate management microservice of a CNF, in response to the configuration instruction, instantiating the certificate management microservice, wherein instantiating the certificate management microservice includes writing a certificate including a certificate key to a secure storage element, receiving, at the certificate management microservice, a service request from an other microservice of the CNF, and in response to the service request, sending certificate information to the other microservice, wherein the certificate information is configured to be usable by the other microservice to read the certificate key from the secure storage element.

The foregoing outlines features of several embodiments so that those skilled in the art better understand the aspects of the present disclosure. Those skilled in the art appreciate that they readily use the present disclosure as a basis for designing or modifying other processes and structures for carrying out the same purposes and/or achieving the same advantages of the embodiments introduced herein. Those skilled in the art also realize that such equivalent constructions do not depart from the spirit and scope of the present disclosure, and that they make various changes, substitutions, and alterations herein without departing from the spirit and scope of the present disclosure.

What is claimed is:

1. A method of operating a cloud-native network function (CNF), the method comprising:
receiving a configuration instruction at a certificate management microservice of the CNF;
in response to the configuration instruction, initializing the certificate management microservice, wherein the initializing the certificate management microservice comprises writing a certificate comprising a certificate key to a secure storage element;
receiving, at the certificate management microservice, a service request from an other microservice of the CNF; and
in response to the service request, sending certificate information to the other microservice, wherein the certificate information is configured to be usable by the other microservice to read the certificate key from the secure storage element.

2. The method of claim 1, wherein the initializing the certificate management microservice further comprises integrating the certificate management microservice to the secure storage element comprising a secure vault or a persistent volume.

3. The method of claim 1, wherein the initializing the certificate management microservice further comprises setting a certificate enrolment protocol.

4. The method of claim 1, wherein the initializing the certificate management microservice further comprises instantiating the certificate manager based on a set of parameters comprising authentication parameters.

5. The method of claim 4, wherein the initializing the certificate management microservice further comprises:
performing an enrolment procedure on the certificate with a certification authority based on the set of parameters; and
starting a renewal timer corresponding to the performing the enrolment procedure on the certificate.

6. The method of claim 5, further comprising:
detecting that an elapsed time of the renewal timer exceeds a renewal threshold; and
in response the detecting that the elapsed time exceeds the renewal threshold:
sending an enrolment renewal request to the certification authority; and
sending a renewal notification to a user of the CNF.

7. The method of claim 6, further comprising, based on a failure of the enrolment renewal request:
sending a second enrolment renewal request to the certification authority; and
sending a failure notification to the user of the CNF.

8. The method of claim 1, wherein the writing the certificate comprising the certificate key to the secure storage element comprises writing an operator-signed certificate to the secure storage element.

9. The method of claim 1, wherein the writing the certificate comprising the certificate key to the secure storage element comprises writing a default certificate to the secure storage element.

10. The method of claim 1, wherein the CNF comprises one of a centralized unit (CU) CNF or a distributed unit (DU) CNF of a radio access network (RAN).

11. A method of managing digital certificates in a cloud network, the method comprising:
sending a service request from an active microservice of a cloud-native network function (CNF) of the cloud network to a certificate management microservice of the CNF;
in response to receiving the service request, sending certificate information from the certificate management microservice to the active microservice; and
based on the certificate information, using the active microservice to read a certificate key from a secure storage element.

12. The method of claim 11, further comprising:
pushing a configuration message to the certificate management microservice; and
in response to receiving the configuration message, instantiating the certificate management microservice, wherein the instantiating the certificate management microservice comprises writing a certificate comprising the certificate key to the secure storage element.

13. The method of claim 12, wherein the pushing the configuration message to the certificate management microservice comprises pushing the configuration message comprising a set of configuration parameters comprising:
one or more identifiers corresponding to a certification authority (CA); and
a certificate enrolment protocol.

14. The method of claim 13, further comprising:
based on the one or more identifiers, sending an enrolment request from the certificate management microservice to the CA,
wherein the enrolment request corresponds to the certificate enrolment protocol.

15. The method of claim 14, further comprising:
using the certificate management microservice to detect an elapsed time greater than a renewal threshold of the certificate; and
in response to the detecting the elapsed time greater than the renewal threshold, sending an enrolment renewal request from the certificate management microservice to the CA.

16. The method of claim 15, wherein
the sending the enrolment renewal request from the certificate management microservice to the CA comprises sending an initial enrolment renewal request, and
the method further comprises periodically sending subsequent enrolment renewal requests from the certificate management microservice to the CA.

17. The method of claim 11, wherein the using the active microservice to read the certificate key comprises reading the certificate key corresponding to a certificate profile based on a 3GPP or open radio access network (O-RAN) specification.

18. The method of claim 11, wherein
the active microservice is a first active microservice of a plurality of active microservices of the CNF, and
the method further comprises:
sending additional certificate information from the certificate management microservice to a second active microservice of the plurality of active microservices; and
based on the additional certificate information, using the second active microservice to read another certificate key from the secure storage element.

19. The method of claim 11, wherein the cloud network comprises an open radio access network (O-RAN).

20. A computer-readable medium including instructions executable by a controller of a network device to cause the controller to perform operations comprising:
receiving a configuration instruction at a certificate management microservice of a cloud-native network function (CNF);
in response to the configuration instruction, instantiating the certificate management microservice, wherein the instantiating the certificate management microservice comprises writing a certificate comprising a certificate key to a secure storage element;
receiving, at the certificate management microservice, a service request from an other microservice of the CNF; and
in response to the service request, sending certificate information to the other microservice, wherein the certificate information is configured to be usable by the other microservice to read the certificate key from the secure storage element.
